(19) United States
(12) Patent Application Publication
(10) Pub. No.: US 2021/0344466 A1
(43) Pub. Date: Nov. 4, 2021

(54) 5G Application Webpage Technology Management Method and System

(71) Applicant: Jiedong Zhong, Gaozhou (CN)

(72) Inventor: Jiedong Zhong, Gaozhou (CN)

(21) Appl. No.: 16/865,473

(22) Filed: May 4, 2020

(51) Int. Cl. H04L 5/00; H04B 7/0413; H04W 4/06; H04W 4/21

(52) U.S. Cl. CPC H04L 5/0042; H04B 7/0413; H04W 4/21; H04L 5/0007; H04W 4/06

(57) ABSTRACT

The present disclosure provides a method and a system. The method includes setting up a webpage technology management system, dividing the webpage technology management system into a social window block and a functional block, setting several sub social window blocks for the social window block, setting and starting social webpage through the functional block, editing the social window block and the functional block, setting up a number of channels and transmitting data and monitoring whether the social window block and the functional block are required to transmit the social service data. The system includes a webpage technology management system comprising of a social window block and a functional block.

### TECHNICAL FIELD

Embodiments of the disclosure generally relate to webpage technology management filed, and more particularly to a 5G application webpage technology management method and system.

### BACKGROUND

Nowadays, the characteristics of people's interpersonal communication are more and more frequent, complex and diverse.

At present, the existing social webpage technology can only provide one kind of service for two people in real time, such as sending information, voice, video, file, picture, location or navigation. This is the reason that only one simple service can be provided in the current 4G technology. When another service is needed, it is necessary to jump out of or close the current service mode for the next step. 4G technology can not support multiple needs and services on fixed or mobile terminals, and cannot provide multiple service needs for three or more users at the same time, resulting in waste of time, unsmooth workflow and inefficient communication.

### SUMMARY

All examples and features mentioned below may be combined in any technically possible way.

Implementations disclosed herein include a 5G application webpage technology management method, comprising:

setting up a webpage technology management system, dividing the webpage technology management system into a social window block and a function block, setting several sub social window blocks for the social window block, setting and starting a social webpage through the functional block, and configuring a corresponding information editing module, an information monitoring module and an information channel module for the social window block and the functional block;

editing the social window block and the functional block;

setting up a number of channels and transmitting data of the sub social window blocks and the functional block to a 5G application terminal through such a number of channels, so as to realize a simultaneous operation of multiple social services or work requirements on a webpage, and a parallel service mode of all of the sub social window blocks;

monitoring whether the social window block and the functional block are required to transmit the social service data; if there is social service data to be output, the social service data will be packaged and then transmitted by the channels; if there is social service data to be input, external social service data will be input to the corresponding sub social window blocks and the functional block for update through the channels.

In some embodiments, the 5G application terminal comprises a first 5G application terminal and a second 5G application terminal; the first 5G application terminal and the second 5G application terminal interactively communicate with each other through the 5G communication technology; the 5G application terminal comprises a 5G cellular phased array antenna unit, which is used for interactive communication between the first 5G application terminal and the second 5G application terminal; the first 5G application terminal and the second 5G application terminal are provided with a number of receiving and transmitting modules; the receiving and transmitting modules of the first 5G application terminal and the second 5G application terminal are connected to two ends of the 5G cellular phased array antenna unit respectively; and the 5G cellular phased array antenna unit comprises a first 5G phased array, a 5G multiple-input-multiple-output array and a second 5G phased array connected in sequence.

In some further embodiments, the first 5G application terminal and the second 5G application terminal include a fixed 5G device terminal, a mobile 5G device terminal, a fixed 5G communication device terminal, a mobile 5G communication device terminal, a 5G computer and a 6G device terminal.

In some embodiments, arranging a server to connect the 5G cellular phased array antenna unit, monitoring whether the social window block and the functional block are required to transmit the social service data; if there is social service data to be output, the social service data of the social window blocks and the functional block are separately packaged and then output to the server through the channels; the server transmits the social service data of the social window blocks and the functional block to the social window blocks and the functional block corresponding to the social webpages of other 5G application terminals; if there is social service data to be input, the social service data will be downloaded from the server to the channels, and uploaded to the corresponding sub social window blocks and the functional block for update to realize the parallel service mode of multiple sub social windows blocks of webpages designed on multiple application terminals.

In some embodiments, the data of the social window blocks and the functional block includes multimedia data, positioning data, information data, voice data, telephone communication data and video communication data.

In some embodiments, under requirements of the social window block and the functional block, under requirements of the social window block and the functional block, editing the social window block and the functional block, setting up a number of channels and transmitting data and monitoring whether the social window block and the functional block are required to transmit the social service data run independently.

In some embodiments, through the functional block, a video webpage and/or a game webpage are/is set up and started; the video webpage is applied to a video field and/or a live field, and the game webpage is applied to the game field.

Implementations disclosed herein include a 5G application webpage technology management system in comprising a webpage technology management system, wherein the webpage technology management system comprises a social window block and a functional block, the social window block includes several sub social window blocks, the functional block includes a social webpage functional unit for setting a social webpage, and the social window block is used for displaying contents of the social webpage;

and comprising an information channel module, an information editing module and an information monitoring module; wherein:

the information editing module is used to edit the social window block and the functional block; and

the information channel module is used to set up a number of channels and transmit the data of the sub social window blocks and the functional block to a 5G application terminal through such a number of channels, so as to realize a simultaneous operation of multiple social services or work requirements on a webpage, and a parallel service mode of all of the sub social window blocks; and

the information monitoring module is used to monitor whether the social window block and the functional block are required to transmit the social service data; if there is social service data to be output, the social service data will be packaged and then transmitted by the information channel module which are configured; if there is social service data to be input, external social service data will be input to the corresponding sub social window blocks and the functional block for update through the configured information channel module.

In some embodiments, the functional block includes a video functional unit for setting and starting a video webpage and/or a live webpage, and the social window block is used for displaying contents of the video webpage and/or the live webpage.

In some embodiments, the functional block includes a game functional unit for setting and starting a game webpage, and the social window block is used for displaying contents of the game.

In some embodiments, the 5G application terminal comprises a first 5G application terminal and a second 5G application terminal; the first 5G application terminal and the second 5G application terminal interactively communicate with each other through the 5G communication technology; the 5G application terminal comprises a 5G cellular phased array antenna unit, which is used for interactive communication between the first 5G application terminal and the second 5G application terminal; the first 5G application terminal and the second 5G application terminal are provided with a number of receiving and transmitting modules; the receiving and transmitting modules of the first 5G application terminal and the second 5G application terminal are connected to two ends of the 5G cellular phased array antenna unit respectively; and the 5G cellular phased array antenna unit comprises a first 5G phased array, a 5G multiple-input-multiple-output array and a second 5G phased array connected in sequence.

In some embodiments, a server is arranged between the 5G cellular phased array antenna unit and the information monitoring module, wherein the information monitoring module monitors whether the social window block and the functional block are required to transmit the social service data; if there is social service data to be output, the social service data of the social window blocks and the functional block are separately packaged and then output to the server through a configured communication channel module; the server transmits the social service data of the social window blocks and the functional block to the social window blocks and the functional block corresponding to the social webpages of other 5G application terminals; if there is social service data to be input, the social service data will be downloaded from the server to the corresponding information channel module, and uploaded to the sub social window blocks and the functional block for update to realize a parallel service mode of multiple sub social windows blocks of webpages designed on multiple application terminals.

### BRIEF DESCRIPTION OF THE DRAWINGS

FIG. 1 is a schematic diagram of the overall structure of the 5G application webpage technology management system, in accordance with some embodiments of the present disclosure.

FIG. 2 is an interactive structure diagram of the first 5G application terminal and the second 5G application terminal, in accordance with some embodiments of the present disclosure.

FIG. 3 is a structural distribution diagram of the social window block and the functional block applied to social communication functions, in accordance with some embodiments of the present disclosure.

FIG. 4 is a structural distribution diagram of the social window block and the functional block applied to video functions, in accordance with some embodiments of the present disclosure.

FIG. 5 is a structural distribution diagram of the social window block and the functional block applied to game functions, in accordance with some embodiments of the present disclosure.

These and other features of the present embodiments will be understood better by reading the following detailed description, taken together with the figures herein described. In the drawings, each identical or nearly identical component that is illustrated in various figures may be represented by a like numeral. For purposes of clarity, not every component may be labeled in every drawing.

### DETAILED DESCRIPTION OF THE DISCLOSURE

The specific embodiments of the disclosure will be further described in combination with the appended drawings and embodiments. The following embodiments are only used to explain the technical solution of the disclosure more clearly and cannot limit the protection scope of the disclosure.

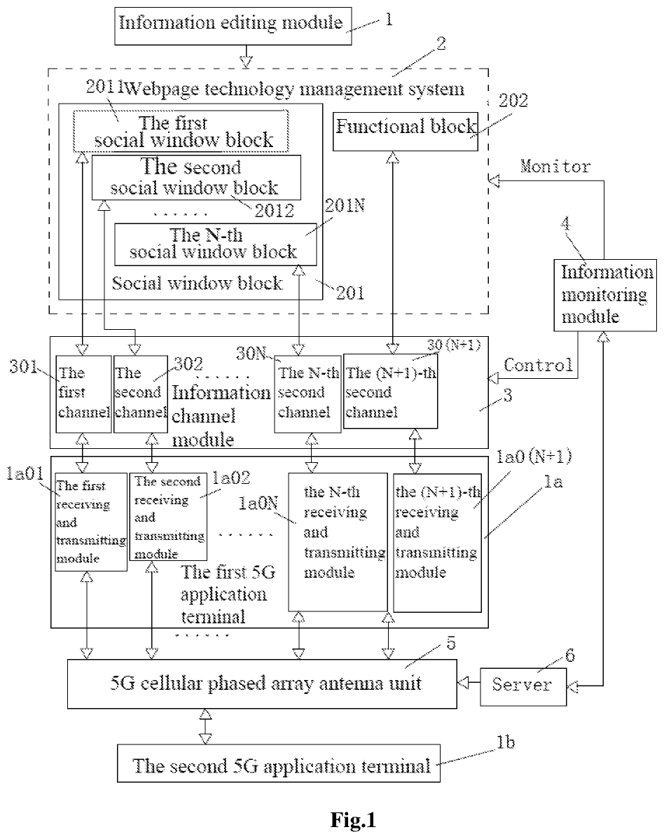

As shown in FIG. 1, this disclosure includes a 5G comprises of setting up a webpage technology management system 2, dividing the webpage technology management system 2 into a number of a social window block 201 and a functional block 202, setting several sub social window blocks for the social window block 201, setting and starting a social webpage through the functional block 202. As shown in FIG. 1, the social window block 201 includes a plurality of sub social window blocks such as the first social window block 2011, the second social window block 2012, . . . , and the N social window block 201N.

The specific embodiments of the disclosure can edit the social window block 201 and the functional block 202. The specific embodiments of the disclosure can set up a number of channels and transmits the data of the sub social window blocks and the functional block to a 5G application terminal through such a number of channels, so as to realize the simultaneous operation of multiple social services or work requirements on a webpage, and a parallel service mode of all of the sub social window blocks.

The specific embodiments of the disclosure can monitor whether the social window block 201 and the functional block 202 are required to transmit the social service data. If there is social service data to be output, the social service data will be packaged and then transmitted by the channels; if there is social service data to be input, the external social service data will be input to the corresponding sub social window block and the functional block 202 for update through the channels.

The functional block 202 can be divided into the following functional areas:

1. The main function area includes: my settings, voice, information, video, phone, address book, etc;

2. File or work editing area includes: new, edit, name, share, send, set, rotate, output, input, collection, delete, etc;

3. Function area includes: expression, information, album, shooting, screenshot, location, collection, business card, red packet, transfer, sharing, file, etc;

4. The sub video area includes: a list of all users who are communicating.

5. The video area includes: displaying the main objects in video communication.

6. The display area of files or works includes: display the files or works being created, edited and shared.

7. The chat Department list area includes: a list of objects that have been recently chatted.

8. Main supporting areas include: new Canada, search, discovery, friends circle, official account, sweep two-dimensional code, games, shopping, third party services, etc.

In the area of the social window block 201, the following format operations can be performed:

1. The formats that can be edited include:

jpg.png.gif.Webp.BMP.PCX.TIF.TGA.EXIF.FPX.SVG.PSD.CDR.PCD.DXF.UFO.EPS.AI.HDRI.RAW.PDF.PDD, etc.

2. The formats that can edit documents include:

TXT.DOC.PPT.XLS.DOCX.XLSX.PPTX, etc.

3: Audio and video formats that can be edited include:

MPEGMPGDAT/MPEG.AVI.MOV.ASF.WMV.NAVI.3GP.REAL VIDEO.MKV.FLV.F4V.RMVB.WebM.HDDVD.BLU-RAY DISD.qsv.CDA.WAV.MP3/MP3 Pro.WMA.RA.MIDI.OGGAPE.FLAC.AAC., etc.

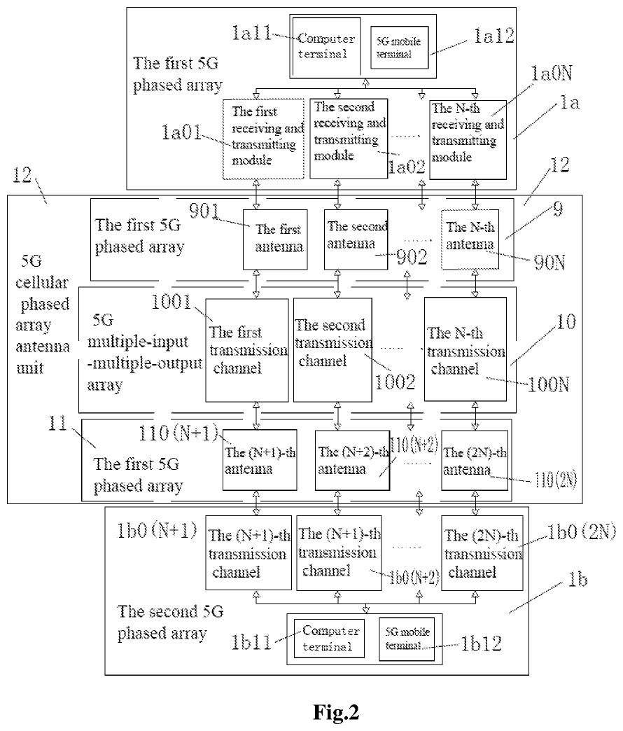

In some embodiments, as shown in FIG. 2, the 5G application terminal comprises a first 5G application terminal 1a and a second 5G application terminal 1b. The first 5G application terminal 1a and the second 5G application terminal 1b interactively communicate with each other through the 5G communication technology. The 5G application terminal comprises a 5G cellular phased array antenna unit 5, which is used for interactive communication between the first 5G application terminal 1a and the second 5G application terminal 1b. The first 5G application terminal 1a and the second 5G application terminal 1b are provided with a number of receiving and transmitting modules. The receiving and transmitting modules of the first 5G application terminal 1a and the second 5G application terminal 1b are connected to the two ends of the 5G cellular phased array antenna unit 5 respectively. And the 5G cellular phased array antenna unit 5 comprises a first 5G phased array 9, a 5G multiple-input-multiple-output array 10 and a second 5G phased array 11 connected in sequence.

The number of receiving and transmitting modules described in the first 5G phased array 9, the 5G multiple-input-multiple-output array 10 and the second 5G phased array 11 can be N as required. Accordingly, the number of receiving and transmitting modules of the first 5G application terminal 1a can be N, and the number of receiving and transmitting modules of the second 5G application terminal 1b can be N.

The receiving and transmitting modules of the first 5G application terminal includes the first receiving and transmitting module 1a01, the second receiving and transmitting module 1a02, . . . , and the N-th receiving and transmitting module 1a0N, the N+1 receiving and transmitting modules 1a0 (N+1). The first receiving and transmitting module 1a01, the second receiving and transmitting module 1a02, . . . , and the N-th receiving and transmitting module 1a0N are respectively interactively connected to the first channel 301, the second channel 302, . . . , the N-th channel 301N of the information channel module 3. The (N+1)-th receiving and transmitting modules 1a0 (N+1) is interactively connected to the (N+1)-th channel 301N of the information channel module 3. The receiving and transmitting modules of the second 5G application terminal 1b include the (N+1)-th receiving and transmitting module 1b0(N+1), the (N+2)-th receiving and transmitting module 1b0(N+2), . . . , and the (2N)-th receiving and transmitting module 1b0(2N).

The first 5G phased array 9 includes a first antenna 901, a second antenna 902, . . . , the N-th antenna 90N. The second 5G phased array 11 includes the (N+1)-th antenna 110 (N+1), the (N+2)-th antenna 110 (N+2), . . . , and the (2N)-th antenna 110 (2N). The 5G multiple-input-multiple-output array 10 includes the first transmission channel 1001, the second transmission channel 1002, . . . , and the N-th transmission channel 100N.

5G technology is adopted in the disclosure, and 5G technology is briefly introduced here. 5G technology consists of three major technologies:

1. OFDM (Orthogonal Frequency Division Multiplexing) technology is to manage the parallel transmission of serial data. It divides the communication channel into several orthogonal sub channels, transforms the data into parallel sub data streams, modulates them respectively in the sub channel transmission, and achieves the purpose of high-speed and efficient data transmission of multiple sub channels at the same time.

2. MIMO (multiple-input-multiple-output) transmission technology is to define and manage multiple independent communication channels of the sender and the receiver, use multi-channel transmission to run transmission at the same time, and maximize the ability of data transmission.

3. Phased antenna array technology is the transmission structure of 5G information flow. It is a large antenna composed of many small antenna arrays because 5G technology uses micro base stations; However, 2G, 3G and 4G use transmission tower base stations.

Based on the high frequency band of 5G technology, the development and application of the disclosure focus on OFDM and MIMO technology of 5G application. The disclosure is also applicable to 6G technology generated in the future. In the OFDM modulation technology, through the multiple information channel module 3, each information channel is connected to the MIMO phased array antenna in serial. Each phased array antenna is serially connected to the receiving and transmitting modules of the 5G application terminal. 5G cellular phased antenna unit 5 is composed of multiple phased array antennas. Under the MIMO phased array antenna technology, multiple phased array antennas can transmit multiple data simultaneously with multiple receiving and receiving devices of 5G mobile terminal equipment, so that multiple users can handle multiple tasks online at the same time.

Based on 5G cellular technology which is multiple phased array antennas and multiple-input-multiple-output array technology, through multiple phased array antennas to transmit information to multiple receiving and transmitting devices of mobile devices at the same time, under OFDM and MIMO technology, the disclosure realizes simultaneous transmission of multiple data and simultaneous online processing of multiple requirements by multiple users.

In further implementations, the first 5G application terminal 1a and the second 5G application terminal 1b include but are not limited to a fixed 5G device terminal, a mobile 5G device terminal, a fixed 5G communication device terminal, a mobile 5G communication device terminal, a 5G computer, a 6G device terminal and so on, such as the computer terminal Tall, the 5G mobile terminal 1a12, the computer terminal 1b11 and the 5G mobile terminal 1b12 in FIG. 2. Social service data can be transmitted from one 5G mobile terminal to another or more 5G mobile terminals through 5G signal relay equipment.

In some embodiments, the 5G application webpage technology management method arranges a server 6 to connect the 5G cellular phased array antenna unit 5. The information monitoring module 4 monitors whether the social window block 201 and the functional block 202 are required to transmit the social service data. If there is social service data to be output, the social service data of the social window block and the functional block 202 are separately packaged and then output to the server 6 through the channels, the server 6 transmits the social service data of the social window block 201 and the functional block 202 to the social window blocks and the functional blocks corresponding to the social webpages of other 5G application terminals. If there is social service data to be input, the social service data will be downloaded from the server 6 to the channels, and uploaded to the corresponding sub social window blocks and the functional block 202 for update to realize the parallel service mode of multiple sub social windows of webpages designed on multiple application terminals.

In some embodiments, the data of the social window block 201 and the functional block 202 includes but is not limited to multimedia data, positioning data, information data, voice data, telephone communication data, video communication data, etc.

In some embodiments, under the requirements of the social window block 201 and the functional block 202, setting up a number of channels and transmitting data and monitoring whether the social window block and the functional block are required to transmit the social service data run independently.

In some embodiments, through the functional block 202, a video webpage and/or a game webpage are/is set up and started, the video webpage is applied to a video field and/or a live field, and the game web page is applied to the game field.

The disclosure realizes the application service of a webpage integrating multiple people, multiple modes and multiple work at the same time, and realize multiple people's applying for the application of social service, game service, video service, live service and so on by on the same webpage at the same time, and has broad application technology prospect.

The disclosure adopts a webpage to integrate application services of multiple people, multiple modes and multiple work, realizing multiple people to gain social services, game services, video services and etc. on the same webpage at the same time. This disclosure can bring broad application technology prospect.

In some embodiments, the data of the social window block 201 and the functional block 202 includes but is not limited to multimedia data, positioning data, information data, voice data, telephone communication data, video communication data, etc.

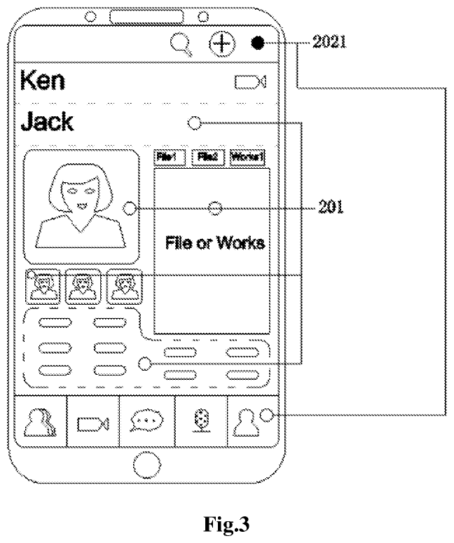

As shown in FIG. 1 and FIG. 3, this disclosure includes a 5G application webpage technology management system comprising a webpage technology management system 2. The webpage technology management system 2 comprises a social window block 201 and a functional block 202. The social window block 201 includes several sub social window blocks. The functional block 202 is provided with a social webpage functional unit. The social webpage functional unit is used for setting a social webpage. The social window block 201 is used for displaying contents of the social webpage. And the 5G application webpage technology management system further comprises an information editing module 1, an information channel module 3 and an information monitoring module 4.

The information editing module 1 is used to edit the social window block 201 and the functional block 202.

The information channel module 3 is used to set up a number of channels and transmit the data of the sub social window blocks and the functional block to a 5G application terminal through such a number of channels, so as to realize the simultaneous operation of multiple social services or work requirements on a webpage, and the parallel service mode of all of the sub social window blocks. As shown in FIG. 1, the information channel module 3 is set with the first channel 301, the second channel 302, . . . , the N-th channel 301N of. The (N+1)-th receiving and transmitting modules 1a0 (N+1) is interactively connected to the (N+1)-th channel 301N of the information channel module 3. The receiving and transmitting modules of the second 5G application terminal 1b include the (N+1)-th receiving and transmitting module 1b0(N+1), the (N+2)-th receiving and transmitting module 1b0(N+2), . . . , and the (2N)-th receiving and transmitting module 1b0(2N).

The information monitoring module 4 is used to monitor whether the social window block 201 and the functional block 202 are required to transmit the social service data; if there is social service data to be output, the social service data will be packaged and then transmitted by the configured information channel module 3; if there is social service data to be input, the external social service data will be input to the corresponding sub social window blocks and the functional block 202 for update through the configured information channel module 3.

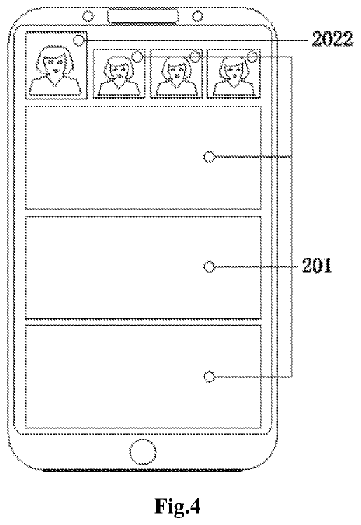

In some embodiments, as shown in FIG. 4, the functional block 202 includes a video functional unit 2022 for setting and starting a video webpage and/or a live field. The social window block 201 is used for displaying contents of the video webpage.

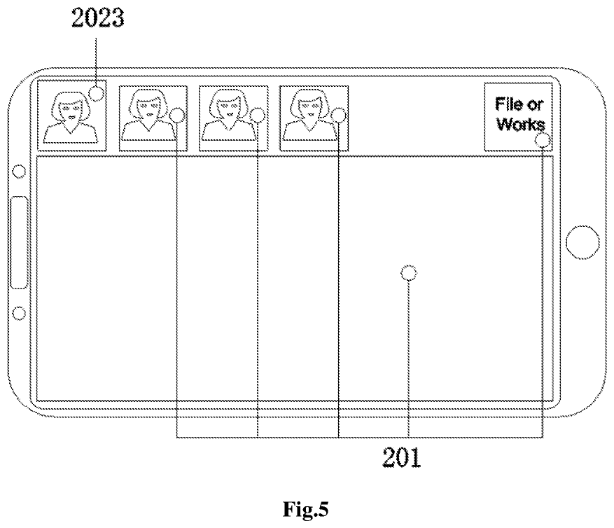

In some embodiments, as shown in FIG. 5, the functional block 202 includes a game functional unit 2023 for setting and starting a game webpage. The social window block 202 is used for displaying contents of the game.

The disclosure realizes that in the environment of HD video communication, multiple users can jointly process multiple business modules at the same time and in real time, such as the compilation, transfer in, transmission, editing, processing, confirmation, storage, sharing, etc. of files, works, pictures and requirements. Under the technology of 5G OFDM and 5G MIMO, both or more parties use 5G application terminal equipment to realize real-time multiple-input-multiple-output bidirectional intelligent office or field demand processing. For example, users can share pictures or documents or works, save and export pictures or documents or works, tune in audio and video, background, environment, stereoscopic display and so on when they send information, send pictures, write documents, write works, modify pictures or documents or works, realize one screen display integration and realize multiple modes or requirements to achieve multi-user simultaneous use of the same web technology, without jumping out of the current web page, interrupting video and jumping out of other modes.

The disclosure adopts 5G technology and the parallel service mode of multiple social window blocks and the functional block 202, so that one webpage integrates multiple social window blocks to realize that two or multiple users can run multiple social service projects or work requirements on that webpage at the same time, and realizes the real-time provision of multiple service requests for multiple users.

In some embodiments, as shown in FIG. 2, the 5G application terminal comprises a first 5G application terminal 1a and a second 5G application terminal 1b. The first 5G application terminal 1a and the second 5G application terminal 1b interactively communicate with each other through the 5G communication technology. The 5G application terminal comprises a 5G cellular phased array antenna unit 5, which is used for interactive communication between the first 5G application terminal 1a and the second 5G application terminal 1b. The first 5G application terminal 1a and the second 5G application terminal 1b are provided with a number of receiving and transmitting modules. The receiving and transmitting modules of the first 5G application terminal 1a and the second 5G application terminal 1b are connected to the two ends of the 5G cellular phased array antenna unit 5 respectively. And the 5G cellular phased array antenna unit 5 comprises a first 5G phased array 9, a 5G multiple-input-multiple-output array 10 and a second 5G phased array 11 connected in sequence.

The number of receiving and transmitting modules described in the first 5G phased array 9, the 5G multiple-input-multiple-output array 10 and the second 5G phased array 11 can be N as required. Accordingly, the number of receiving and transmitting modules of the first 5G application terminal 1a can be N, and the number of receiving and transmitting modules of the second 5G application terminal 1b can be N.

The receiving and transmitting modules of the first 5G application terminal includes the first receiving and transmitting module 1a01, the second receiving and transmitting module 1a02, . . . , and the N-th receiving and transmitting module 1a0N, the N+1 receiving and transmitting modules 1a0 (N+1). The first receiving and transmitting module 1a01, the second receiving and transmitting module 1a02, . . . , and the N-th receiving and transmitting module 1a0N are respectively interactively connected to the first channel 301, the second channel 302, . . . , the N-th channel 301N of the information channel module 3. The (N+1)-th receiving and transmitting modules 1a0 (N+1) is interactively connected to the (N+1)-th channel 301N of the information channel module 3. The receiving and transmitting modules of the second 5G application terminal 1b include the (N+1)-th receiving and transmitting module 1b0(N+1), the (N+2)-th receiving and transmitting module 1b0(N+2), . . . , and the (2N)-th receiving and transmitting module 1b0(2N).

The first 5G phased array 9 includes a first antenna 901, a second antenna 902, . . . , the N-th antenna 90N. The second 5G phased array 11 includes the (N+1)-th antenna 110 (N+1), the (N+2)-th antenna 110 (N+2), . . . , and the (2N)-th antenna 110 (2N). The 5G multiple-input-multiple-output array 10 includes the first transmission channel 1001, the second transmission channel 1002, . . . , and the N-th transmission channel 100N.

In further implementations, the first 5G application terminal 1a and the second 5G application terminal 1b include but are not limited to a fixed 5G device terminal, a mobile 5G device terminal, a fixed 5G communication device terminal, a mobile 5G communication device terminal, a 5G computer, a 6G device terminal and so on, such as the computer terminal Tall, the 5G mobile terminal 1a12, the computer terminal 1b11 and the 5G mobile terminal 1b12 in FIG. 2. Social service data can be transmitted from one 5G mobile terminal to another or more 5G mobile terminals through 5G signal relay equipment.

In some embodiments, the 5G application webpage technology management method arranges a server 6 to connect the 5G cellular phased array antenna unit 5. The information monitoring module 4 monitors whether the social window block 201 and the functional block 202 are required to transmit the social service data. If there is social service data to be output, the social service data of the social window block and the functional block 202 are separately packaged and then output to the server 6 through the channels, the server 6 transmits the social service data of the social window block 201 and the functional block 202 to the social window blocks and the functional blocks corresponding to the social webpages of other 5G application terminals. If there is social service data to be input, the social service data will be downloaded from the server 6 to the channels, and uploaded to the corresponding sub social window blocks and the functional block 202 for update to realize the parallel service mode of multiple sub social windows of webpages designed on multiple application terminals.

Although the methods and systems have been described relative to specific embodiments thereof, they are not so limited. Many modifications and variations may become apparent in light of the above teachings. Many additional changes in the details, materials, and arrangement of parts, herein described and illustrated, may be made by those skilled in the art. A number of implementations have been described. Nevertheless, it will be understood that additional modifications may be made without departing from the scope of the inventive concepts described herein, and, accordingly, other implementations are within the scope of the following claims.

What is claimed is:

1. A 5G application webpage technology management method, comprising:
setting up a webpage technology management system, dividing the webpage technology management system into a social window block and a function block, setting several sub social window blocks for the social window block, setting and starting a social webpage through the functional block, and configuring a corresponding information editing module, an information monitoring module and an information channel module for the social window block and the functional block;
editing the social window block and the functional block;
setting up a number of channels and transmitting data of the sub social window blocks and the functional block to a 5G application terminal through such a number of channels, so as to realize a simultaneous operation of multiple social services or work requirements on a webpage, and a parallel service mode of all of the sub social window blocks;
monitoring whether the social window block and the functional block are required to transmit the social service data; if there is social service data to be output, the social service data will be packaged and then transmitted by the channels; if there is social service data to be input, external social service data will be input to the corresponding sub social window blocks and the functional block for update through the channels.

2. The 5G application webpage technology management method according to claim 1, wherein the 5G application terminal comprises a first 5G application terminal and a second 5G application terminal; the first 5G application terminal and the second 5G application terminal interactively communicate with each other through the 5G communication technology; the 5G application terminal comprises a 5G cellular phased array antenna unit, which is used for interactive communication between the first 5G application terminal and the second 5G application terminal; the first 5G application terminal and the second 5G application terminal are provided with a number of receiving and transmitting modules; the receiving and transmitting modules of the first 5G application terminal and the second 5G application terminal are connected to two ends of the 5G cellular phased array antenna unit respectively; and the 5G cellular phased array antenna unit comprises a first 5G phased array, a 5G multiple-input-multiple-output array and a second 5G phased array connected in sequence.

3. The 5G application webpage technology management method according to claim 2, wherein the first 5G application terminal and the second 5G application terminal include a fixed 5G device terminal, a mobile 5G device terminal, a fixed 5G communication device terminal, a mobile 5G communication device terminal, a 5G computer and a 6G device terminal.

4. The 5G application webpage technology management method according to claim 2, further comprising:
arranging a server to connect the 5G cellular phased array antenna unit, monitoring whether the social window block and the functional block are required to transmit the social service data; if there is social service data to be output, the social service data of the social window blocks and the functional block are separately packaged and then output to the server through the channels; the server transmits the social service data of the social window blocks and the functional block to the social window blocks and the functional block corresponding to the social webpages of other 5G application terminals; if there is social service data to be input, the social service data will be downloaded from the server to the channels, and uploaded to the corresponding sub social window blocks and the functional block for update to realize the parallel service mode of multiple sub social windows blocks of webpages designed on multiple application terminals.

5. The 5G application webpage technology management method according to claim 1, wherein the data of the social window blocks and the functional block includes multimedia data, positioning data, information data, voice data, telephone communication data and video communication data.

6. The 5G application webpage technology management method according to claim 1, further comprising:
under requirements of the social window block and the functional block, editing the social window block and the functional block, setting up a number of channels and transmitting data and monitoring whether the social window block and the functional block are required to transmit the social service data run independently.

7. The 5G application webpage technology management method according to claim 1, further comprising:
through the functional block, a video webpage and/or a game webpage are/is set up and started; the video webpage is applied to a video and/or a live field, and the game webpage is applied to the game field.

8. A 5G application webpage technology management system, comprising a webpage technology management system, wherein the webpage technology management system comprises a social window block and a functional block, the social window block includes several sub social window blocks, the functional block includes a social webpage functional unit for setting a social webpage, and the social window block is used for displaying contents of the social webpage;
and comprising an information channel module, an information editing module and an information monitoring module; wherein:
the information editing module is used to edit the social window block and the functional block; and
the information channel module is used to set up a number of channels and transmit data of the sub social window blocks and the functional block to a 5G application terminal through such a number of channels, so as to realize a simultaneous operation of multiple social services or work requirements on a webpage, and a parallel service mode of all of the sub social window blocks; and
the information monitoring module is used to monitor whether the social window block and the functional block are required to transmit the social service data; if there is social service data to be output, the social service data will be packaged and then transmitted by the information channel module which are configured; if there is social service data to be input, external social service data will be input to the sub social window blocks and the functional block for update through the configured information channel module.

9. The 5G application webpage technology management system according to claim 8, wherein the functional block includes a video functional unit for setting a video webpage or/and a live webpage, and the social window block is used for displaying contents of the video webpage.

10. The 5G application webpage technology management system according to claim 8, wherein the functional block includes a game functional unit for setting a game webpage, and the social window block is used for displaying contents of the game.

11. The 5G application webpage technology management system according to claim 8, wherein the 5G application terminal comprises a first 5G application terminal and a second 5G application terminal; the first 5G application terminal and the second 5G application terminal interactively communicate with each other through the 5G communication technology; the 5G application terminal comprises a 5G cellular phased array antenna unit, which is used for interactive communication between the first 5G application terminal and the second 5G application terminal; the first 5G application terminal and the second 5G application terminal are provided with a number of receiving and transmitting modules; the receiving and transmitting modules of the first 5G application terminal and the second 5G application terminal are connected to two ends of the 5G cellular phased array antenna unit respectively; and the 5G cellular phased array antenna unit comprises a first 5G phased array, a 5G multiple-input-multiple-output array and a second 5G phased array connected in sequence.

12. The 5G application webpage technology management system according to claim 11, wherein a server is arranged between the 5G cellular phased array antenna unit and the information monitoring module, wherein the information monitoring module monitors whether the social window block and the functional block are required to transmit the social service data; if there is social service data to be output, the social service data of the social window blocks and the functional block are separately packaged and then output to the server through a configured communication channel module; the server transmits the social service data of the social window blocks and the functional block to the social window blocks and the functional block corresponding to the social webpages of other 5G application terminals; if there is social service data to be input, the social service data will be downloaded from the server to the information channel module, and uploaded to the corresponding sub social window blocks and the functional block for update to realize a parallel service mode of multiple sub social windows blocks of webpages designed on multiple application terminals.
